(19) United States
(12) Patent Application Publication
(10) Pub. No.: US 2012/0096073 A1
(43) Pub. Date: Apr. 19, 2012

(54) LOCAL POLLING METHOD AND SYSTEM FOR REAL TIME UPDATING OF WEB-BASED SERVICES

(75) Inventor: Dean Elwood, London (GB)

(73) Assignee: BLABBELON, INC., New York, NY (US)

(21) Appl. No.: 13/021,465

(22) Filed: Feb. 4, 2011

Related U.S. Application Data
(60) Provisional application No. 61/394,095, filed on Oct. 18, 2010.

(51) Int. Cl. G06F 15/16

(52) U.S. Cl. 709/203

(57) ABSTRACT

A method and system for providing real-time, web-based updates is disclosed. For instance, a user requests over the user's web browser a web browser-based application from a web server to receive a web page and display the same on a user interface. A client-object of the web browser connects using a TCP or UDP connection to a middleware layer and said middleware layer is further connected to a content source. Updates from the content source are directed to the middleware layer and sent or pushed to said client-object over the TCP or UDP connection. Polling on the client side, specifically constant and consistent polling between the client-object and a scripting language recognizes updates and updates the user interface with said updates.

### PRIORITY AND RELATED APPLICATION

This application claims priority to U.S. Provisional Patent Application Ser. No. 61/394,095, filed Oct. 18, 2010, entitled “LOCAL POLLING METHOD FOR REAL TIME UPDATING FOR WEB-BASED SERVICES,” which is hereby incorporated by reference in its entirety.

### FIELD OF THE INVENTION

The present invention relates to providing real-time updating information for web based services.

### BACKGROUND OF THE INVENTION

Scaling refers to the number of simultaneous users manageable by a single server, and the power consumed by the server per user. Scalability is a typical and well-known limitation present in the gaming services and in the telephony industry. Some advances in efficiency have been made in the telephony industry, but scaling still remains ultimately the limiting factor. Web based services are, from a service delivery point of view, generally simple and scalable. However, where real-time or dynamic data is concerned, delivery of web services can be complex and difficult to scale.

Prior art systems exist for delivery of real-time updating information from a web server to a web browser, but such systems require the use of technology solutions that are often problematic, inefficient or inconvenient. The common design and architecture in existing systems of real-time web based services use a technology commonly referred to as AJAX (Asynchronous JAVA and XML). Such services rely on a constant poll to a server to provide updates to a webpage for display. Such services require constant server resources, as the client browser has to make a periodic request to a server every few seconds in order to see if there is additional data to display. This dramatically increases the number of user-generated requests to web servers and their back-end systems (databases, or other). This can lead to longer response times and/or additional hardware needs.

Developers have several other choices for prior art real-time updating information delivery and each has their own inefficiencies or problems with respect to building Internet-based technology that allows for web servers to instantly send messages to the browser. Some example solutions include:

HTTP server push or HTTP streaming which is a mechanism for sending data from a web server to a web browser. HTTP server push can be achieved through several mechanisms. Generally the web server does not terminate a connection after response data has been served to a client. The web server leaves the connection open such that if an event is received, it can immediately be sent to one or multiple clients. Otherwise the data would have to be queued until the client's next request is received.

Long polling is a variation of the traditional polling technique and allows emulation of an information push from a server to a client. With long polling, the client requests information from the server in a similar way to a normal poll. However, if the server does not have any information available for the client, instead of sending an empty response, the server holds the request and waits for some information to be available. Once the information becomes available (or after a suitable timeout), a complete response is sent to the client. The client will normally then immediately re-request information from the server, so that the server will almost always have an available waiting request that it can use to deliver data in response to an event.

A Java Pushlet is a technique originally developed for JAVA web applications, though the same techniques can be employed on other web frameworks as well. In this technique, the server takes advantage of persistent HTTP connections and leaves the response perpetually “open” (i.e. it never terminates the response), effectively fooling the browser into continuing in “loading” mode after the initial page load would normally be complete. The server then periodically sends snippets of javascript to update the content of the page, thereby achieving push capability. One serious drawback to this method, however, is the lack of control the server has over the browser timing out. A page refresh is always necessary if a timeout occurs on the browser end.

A real-time delivery service is desired that overcomes industry limitations in terms of scalability and creates highly scalable systems at low cost. A real-time delivery system and method is desired that provides a web browser with updates instantaneously or in real-time. It is desired that said system and method push real-time updates directly to the web page of a web browser. It is desired that said system and method notify a web browser that updates are available for retrieval. A system and method is desired that utilizes minimal to no resources from a web service provider or a web server. A system and method is desired that provides polling at the client-side such as between a client object and a scripting language on a users' computer. A system and method is further desired that uses a middleware layer that interfaces between a web browser and data source or content source. A system and method is desired wherein a client object interfaces between a middleware layer and a web browser. A system and method is further desired that has value in the communications industry and in broader applications.

### BRIEF SUMMARY OF THE INVENTION

A method and system for providing real-time, web-based updates is disclosed. For instance, a user requests over the user's web browser a web browser-based application from a web server to receive a web page and display the same on a user interface. A client-object of the web browser connects using a TCP or UDP connection to a middleware layer and said middleware layer is further connected to a content source. Updates from the content source are directed to the middleware layer and sent or pushed to said client-object over the TCP or UDP connection. Polling on the client side, specifically constant and consistent polling between the client-object and a scripting language recognizes updates and updates the user interface with said updates.

### BRIEF DESCRIPTION OF THE DRAWING

FIG. 1 is schematic diagram of an Internet based system for accessing real-time streaming data according to the present invention.

FIG. 2 is a flow diagram explaining the real-time updating of a web browser according to the present invention.

### DETAILED DESCRIPTION OF THE INVENTION

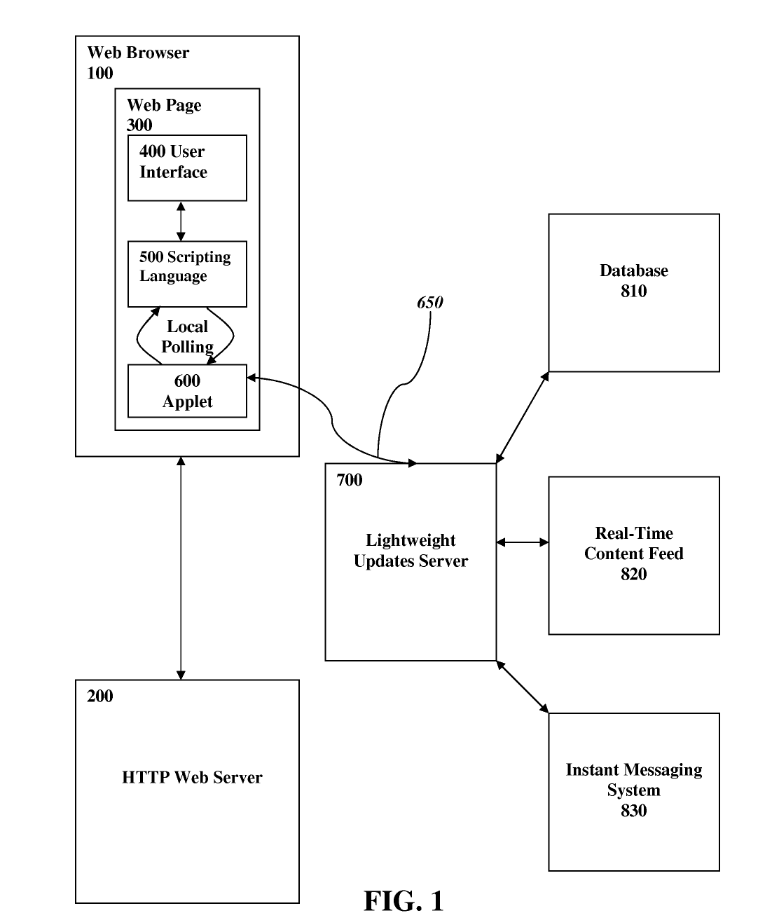

As shown in FIG. 1, a user web browser 100 connects to a HTTP web server 200 thereby providing a web page 300 for display on the web browser 100. The web page 300 contains a user-interface 400 (which may be built by HTML), a scripting language or source code 500 and a client object or applet 600. The scripting language 500 includes but is not limited to JavaScript source code while the Applet 600 may comprise JAVA object, Active X, Flash, JAVA applet complied binary code, or other technology capable of managing a network socket connection and able to be executed at the request of a browser.

The web browser 100 executes both the scripting language 500 and the applet 600. The scripting language 500 and the applet 600 maintains a communication topology by consistently and constantly calling functions within the applet 600. This communication topology is termed local polling as this constant communication topology is polling against the client-object or applet 600 that resides on the user's computer. By employing local polling no web server 200 resources are consumed. The execution of the client object or applet 600 by the web browser 100 creates a connection 650 to a middleware interface layer or lightweight updates server 700 using either a persistent stateful TCP or stateless UDP socket connection. This connection is not HTTP based but rather utilizes a lightweight TCP or UDP connection to the lightweight updates server 700 and again ensures minimal or no resources are required at the web server 200 to maintain a communications connection.

In addition to the connection to the applet 600, the lightweight updates server 700 is connected to one or more data sources or content sources 810, 820, 830 that provides the lightweight updates server 700 with updates. Non-limiting examples of data sources or content sources 810, 820, 830 include but are not limited to a database server 810 which may contain information where a user requires to be notified of changes or may monitor the state of something of interest to the user, real-time content feed 820 which may be a feed of current or rapidly changing information such as stock prices from the New York Stock Exchange, and/or an instant messaging system 830 which may be an XMPP based instant messaging system requiring real-time messages from other users to be displayed in the web page 300. The lightweight updates server 700 may be custom configured to the content source 810, 820, 830 to which it is connected and recognize specific types of events that are desired by the user. Non-limiting examples of real-time events that may be desired by a user include notification when another user logs in and/or out of a communication system such as an instant messaging system notification of a chat or instant messages and notification of news events or any other real-time information occurrence that arises to an end user. All such desired information is pushed to the party who requested the information.

Information such as changes or updates that are identified in the content source 810, 820, 830 is recognized by the lightweight updates server 700 and then pushed to the applet 600 using the connection 650. The connection 650 between the lightweight updates server 700 and the applet 600 facilitates sending or pushing to the applet 600 messages that real-time information (changes or updates) is available. The messages from the lightweight updates server 700 either notifies the applet 600 of the availability of updates by sending the updates to the applet 600 directly or instructing the applet 600 to obtain the updates from the web server 200.

The applet 600 takes the information received from the lightweight updates server 700 and supplies it to the web browser 100, therein acting as an interface between the lightweight updates server 700 and the web browser 100. The information pushed to or obtained by the applet 600 is then used to update the user interface 400 in the web page 300. Specifically, local polling between the applet 600 and scripting language 500 identifies when information is available at the applet 600. The scripting language then retrieves the information and processes the information by, for example, using a JavaScript loop acting on this information or displaying or rendering it to the user. One non-limiting example of a JavaScript function that may be utilized is shown below:

function pollAndDisplay( ) {
var myObject = document.getElementById(‘myObject’); // Get a handle to
our client-side Object
var dataJSON = myObject.getMessages( );
// Ask our client-side Object if it has any messages for us

| | |
|---|---|
| if (dataJSON != “”) { | // We have messages |

| var messlist = document.getElementById(‘messages’); // Get a | |
|---|---|
| handle to our display area | |
| messlist.innerHTML = dataJSON; | // Render the |

message to the
user

}

setTimeout(“pollAndDisplay( )”, 200); // Wait 200 milliseconds and
then do it all over again

}

In contrast to the prior art where constant requests must be made to the web server 200 to identify and retrieve updates, here the sending or pushing of information to the web browser 100 allows the service provider to notify the user that information updates are available without using resources at the HTTP web server 200 end. For example, the lightweight update server 700 may be designed for connection to an online instant messaging system 830 that indicates in real-time when users come on and off the instant messaging system. Here user 1 is logged on to a web version of the instant messaging system after connecting through the HTTP web server 200, when a user 2 logs on to the instant messaging system the lightweight updates server 700 recognizes the event and pushes the message to the applet 600 in the web page 300 indicating that user 2 is now on line. Specifically, the local polling between the scripting language 500 and the applet 600 collects information and then updates the user interface 400 with the notice that user 2 is available on the instant messaging system. Here, the web page 300 would not need to go back to the HTTP web server 200 as the updating of the presence of user 2 is performed using the information supplied to the lightweight update server 700 from the content source 810, 820, 830. Taking this example a step further, if the system implemented is an instant messaging system the lightweight updates server 700 would plumb into the back end of the instant messaging system which already has a mechanism used to monitor when people come on and off line.

In another embodiment, rather than pushing information from the lightweight update server 700 via connection 650 to the applet 600, a message is sent to the applet 600 directing the applet 600 to collect the change or update information from a location holding the information. For instance, a message may be sent to the applet 600 that an update is available and may be accessed from the HTTP web server 200. Here, the polling of the HTTP web server 200 is pre-determined as the polling is only performed once it is known that such change or update information is available.

It should be noted that in either case of pushing information directly to the applet 600 or directing the applet 600 to retrieve information from elsewhere, the communication topology or local polling between the scripting language 500 and the applet 600 used to recognize updates occurs constantly and at the client-side. In one embodiment, the local polling of the present invention can have extremely small polling intervals without latency. In one non-limiting example, the interval can be as small as 50 milliseconds.

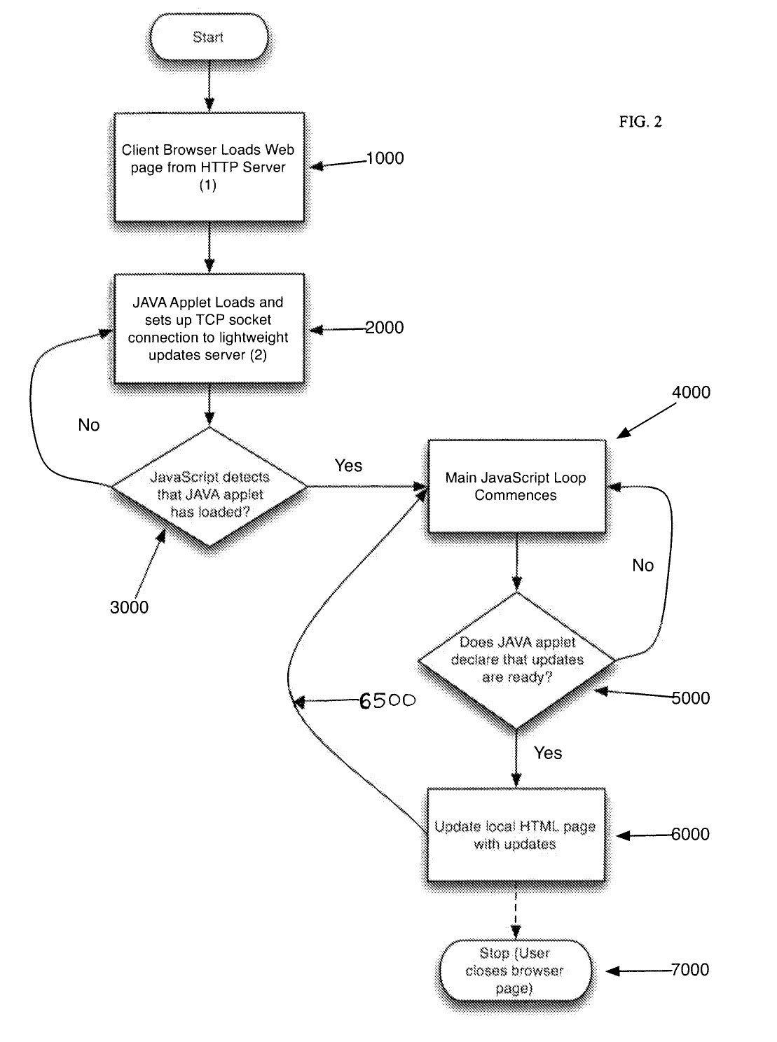

FIG. 2 shows a flow diagram explaining the real-time updating of a web browser 100 according to the present invention. The user's web browser 100 is loaded with web page 300 from the HTTP web server 200. Step 1000. The applet 600 loads and sets up the connection 650 to the lightweight updates server 700, step 2000. If the scripting language 500 does not detect that applet 600 has loaded then the system returns to step 2000. If, however, the scripting language 5000 detects the applet 600 has loaded then the local polling or main scripting language loop commences at 4000. The system then determines if updates are ready at step 5000, if no updates are ready the system returns to step 4000 to continue local polling, if updates are detected then the system updates the local web page 300 with the updates at step 6000. As noted in the Javascript function described above, the Javascript loop is constantly looping to process steps 4000, 5000 and 6000 and then returns to step 4000. This constant looping is represented by line 6500 and it happens until the user closes the web browser 100 which then stops or ends the system at step 7000.

The present invention provides several notable features to real-time messaging and presence systems that in the prior art requires large scale and a publish/subscribe model for updates and content. For instance, the prior art uses HTTP as the connection system which is a very resource intensive protocol. The prior art is further distinguished and disadvantaged by the fact that said prior art systems all require a consistent polling of servers at intervals, even when there is no data for the client/consuming application to be delivered to a user thereby making the prior art systems wasteful of system resources. In contrast, the present invention provides very high scalability with a low resource requirement at the service provider side. In the case of utilizing UDP for the communications protocol between client-side object 600 and service providers servers 200, there is a zero resource requirement due to UDP being a stateless and connectionless protocol.

The present invention also provides the ability for a service provider to deliver or push to the user real-time or instantaneous updates in a very timely manner. This pushing of real-time updates can be achieved at very high speed polling rates as local polling has no latency and consumes no service provider server resources. Timeliness is of value to systems which are real-time in nature, such as is the case with communications systems. In contrast, the prior art systems are based on a “pull” system, by polling for updates regardless of whether updates are present. Another notable feature of the present invention is that there are no issues or problems with browser time-outs, such as would be experienced with a system such as the JAVA Pushlet system.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A method for providing real-time web-based service updates by requesting over a web browser updates for a web browser-based application, receiving a web page from a web server, displaying the web page on a user interface of said web browser and comprising the steps of:
connecting a client-object of said web browser with a middleware layer, said middleware layer connected to a content source;
sending updates from said content source received by said middleware layer to said client-object; and
updating said user interface with said updates.

2. The method of claim 1, further comprising:
polling said client-object, wherein polling is performed between said client-object and a scripting language of said web browser,
wherein polling provides updates received by said client-object to said scripting language,
wherein updates sent to the scripting language are used to update the user interface, and
wherein resources of said web server are conserved by said polling.

3. The method of claim 1, wherein sending said updates includes sending a message that updates are available and must be retrieved from the web server.

4. The method of claim 1, wherein said updates received by said client-object are sent directly to said client-object from the middleware layer.

5. The method of claim 1, wherein said connection between client-object and said middleware layer is a persistent connection.

6. The method of claim 1, wherein said connection between said client-object and said middleware layer is a byte-level TCP connection.

7. The method of claim 6, wherein said TCP is stateful.

8. The method of claim 1, wherein said connection between said client object and said middleware layer is a byte-level UDP connection.

9. The method of claim 8, wherein said UDP is stateless.

10. The method of claim 1, wherein said middleware layer is a lightweight updates server.

11. The method of claim 1, wherein said polling of said client-object is constant.

12. A method for providing real-time web-based updates comprising:
requesting a web browser-based application from a web server by a web browser;
providing a persistent lightweight byte-level connection between a middleware layer and an client-object of said web browser;
connecting said middleware layer to at least one content source, said content source realizing updates; and
pushing said updates from said content sources to said middleware layer for transmission to said client-object using said persistent lightweight byte-level connection; and
polling said client-object, wherein polling is performed between said client-object and a scripting language of said web browser, wherein polling provides updates received by said client-object to said scripting language; and
updating a user interface of said web browser with said updates, wherein resources of said web server are conserved by said polling.

13. The method of claim 12, wherein said user interface is updated by updates recognized by said client-object.

14. The method of claim 13, wherein said updates are recognized by polling said client-object by a scripting language on said web browser.

15. The method of claim 12, wherein said content source includes a database server, a real-time content feed and an instant messaging system.

16. A system for providing real-time web-based updates comprising:
a server computer;
a client computer coupled to the server computer over a network,
wherein the client computer requests updates for a web browser-based application,
wherein a persistent lightweight byte-level connection is established between a middleware layer and a client-object on a web browser of said client computer,
wherein said middleware layer is connected to at least one content source, said content source realizing updates,
wherein updates from said content sources are pushed to said middleware layer for transmission to said client-object using said persistent lightweight byte-level connection, and
wherein a user interface of said web browser is updated with said updates.

17. The system of claim 16, wherein said user interface is updated by updates recognized by said client-object.

18. The method of claim 17, wherein said updates are recognized by polling said client-object by a scripting language on said web browser.

19. The method of claim 16, wherein said content source includes a database server, a real-time content feed and an instant messaging system.
